(19) United States
(12) Patent Application Publication
(10) Pub. No.: US 2003/0004268 A1
(43) Pub. Date: Jan. 2, 2003

(54) Polyimide blends, method of making, and articles made therefrom

(75) Inventors: Uttandaraman Sundararaj, Edmonton (CA); Navjot Singh, Rye, NY (US); Sterling Bruce Brown, Niskayuna, NY (US); Robert R. Gallucci, Mt. Vernon, IN (US)

Correspondence Address: John B. Yates, GE Plastics, One Plastics Avenue, Pittsfield, MA, 01201, US

(73) Assignee: General Electric Company

(21) Appl. No.: 09/855,052

(22) Filed: May 14, 2001

(51) Int. Cl. C08F 8/00

(52) U.S. Cl. 525/100

(57) ABSTRACT

A molding composition with improved impact strength and surface gloss is disclosed comprising: (a) at least one thermoplastic polyimide resin; (b) at least one second thermoplastic resin which is chemically distinct from any polyimide resin; and (c) a poly(diorganosiloxane), and optional additives such as pigments, fillers, lubricants, viscosity modifiers, heat stabilizers, flame retardants, and the like. In another embodiment a method of making a polyimide molding composition is disclosed, which comprises blending (a) at least one thermoplastic polyimide resin; (b) at least one second thermoplastic resin which is chemically distinct from any polyimide resin; and (c) a poly(diorganosiloxane). In another embodiment articles made from the molding compositions are disclosed.

### CROSS-REFERENCE TO RELATED APPLICATIONS

Not Applicable

### FEDERALLY SPONSORED RESEARCH

Not Applicable

### BACKGROUND OF THE INVENTION

The present invention relates to polyimide molding compositions, and in particular to polyimide molding compositions comprising a polyetherimide and a second polymer.

Thermoplastic polyimide polymers are known to provide high heat resistance, exceptional strength, and excellent processability. Further improvement in the properties of thermoplastic polyimides has been achieved by formation and molding of binary thermoplastic polyimide compositions comprising polyetherimide resins in combination with at least one other type of resin. Binary blends of polyetherimides with polycarbonate resins, polyestercarbonate resins, and polyarylate resins are disclosed, for example, in U.S. Pat. No. 5,852,085 to Brown et al. and the references cited therein. While such resins are well suited for their current applications, there nonetheless remains a need for high performance formulations that will provide improved characteristics, including higher impact strength, improved surface gloss, and improved processability.

### SUMMARY OF THE INVENTION

The above-described characteristics are provided by the present invention which in one embodiment comprises a polyimide molding composition comprising: (a) at least one thermoplastic polyimide resin; (b) at least one second thermoplastic resin which is chemically distinct from any polyimide resin; and (c) a poly(diorganosiloxane), and optional additives such as pigments, fillers, lubricants, viscosity modifiers, heat stabilizers, flame retardants, and the like. In another embodiment the present invention comprises a method of making a polyimide molding composition, which comprises blending (a) at least one thermoplastic polyimide resin; (b) at least one second thermoplastic resin which is chemically distinct from any polyimide resin; and (c) a poly(diorganosiloxane). In another embodiment the present invention comprises articles made from the molding compositions.

### DESCRIPTION OF THE DRAWINGS

Not applicable

### DETAILED DESCRIPTION OF THE INVENTION

For the sake of brevity, the constituents of the molding compositions are defined as “components” irrespective of whether a reaction between said constituents occurs during any processing step. Thus, the compositions may include said components and any reaction products thereof.

Useful thermoplastic polyimides include those of the general formula (I)

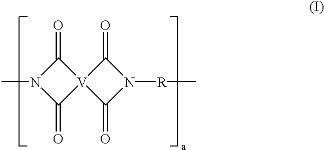

wherein a is an integer greater than 1, e.g., in the range from about 10 to about 10,000 or more; and V is a tetravalent linker without limitation, as long as the linker does not impede synthesis or use of the thermoplastic polyimide. Suitable linkers include but are not limited to: (a) substituted or unsubstituted, saturated, unsaturated or aromatic monocyclic and polycyclic groups having about 5 to about 50 carbon atoms, (b) substituted or unsubstituted, linear or branched, saturated or unsaturated alkyl groups having 1 to about 30 carbon atoms; or combinations thereof. Suitable substitutions and/or linkers include, but are not limited to, ethers, epoxides, amides, esters, and combinations thereof. Preferred linkers include but are not limited to tetravalent aromatic radicals of formula (II), such as

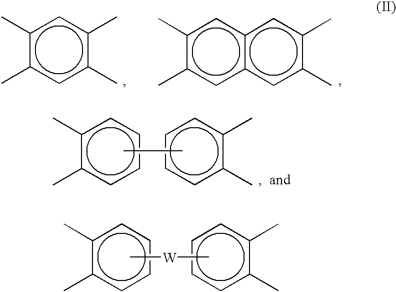

wherein W is a divalent moiety selected from the group consisting of —O—, —S—, —C(O)—, —SO₂—, CyH₂y (y being an integer from 1 to 5), and halogenated derivatives thereof, including perfluoroalkylene groups, or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent radicals of formula (III).

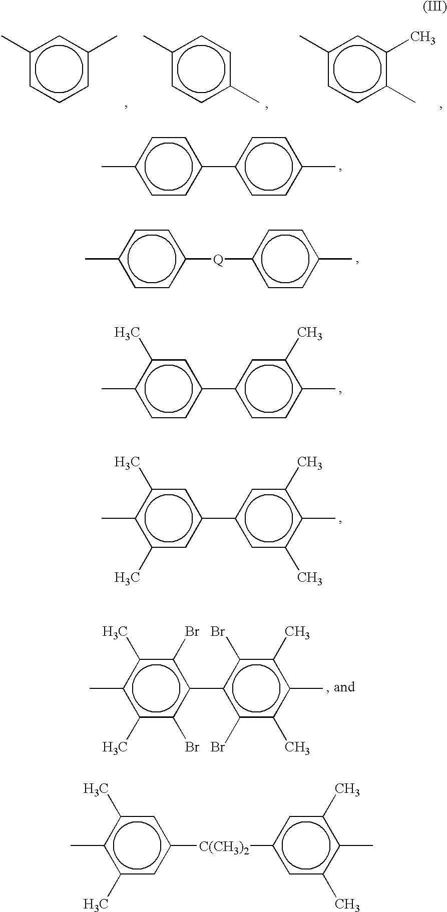

wherein Q includes but is not limited to divalent a divalent moiety selected from the group consisting of —O—, —S—, —C(O)—, —SO2—, CyH₂y (y being an integer from 1 to 5), and halogenated derivatives thereof, including perfluoroalkylene groups.

R in formula (I) includes but is not limited to substituted or unsubstituted divalent organic radicals such as: (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (IV)

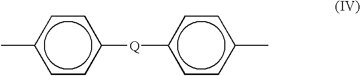

wherein Q is as defined above.

Preferred classes of polyimides include polyamidimides and polyetherimides, particularly those polyetherimides known in the art which are melt processible, such as those whose preparation and properties are described in U.S. Pat. Nos. 3,803,085 and 3,905,942.

Preferred polyetherimide resins comprise more than 1, typically about 10 to about 1000 or more, and more preferably about 10 to about 500 structural units, of the formula (V)

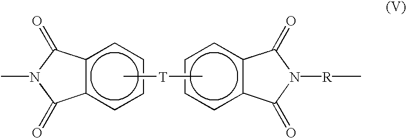

wherein R is as defined above for formula (I); T is —O— or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent radicals of formula (III) as defined above.

In one embodiment, the polyetherimide may be a copolymer which, in addition to the etherimide units described above, further contains polyimide structural units of the formula (VI)

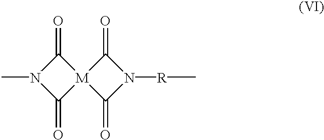

wherein R is as previously defined for formula (I) and M includes, but is not limited to, radicals of formula (VII).

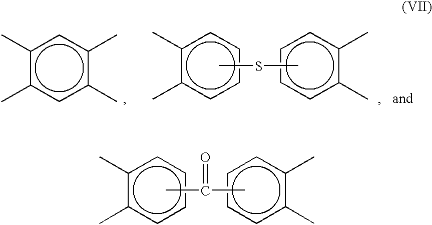

The polyetherimide can be prepared by any of the methods well known to those skilled in the art, including the reaction of an aromatic bis(ether anhydride) of the formula (VIII)

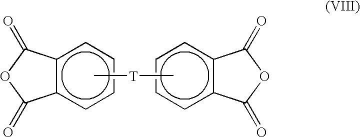

with an organic diamine of the formula (IX)

H₂N—R—NH₂ (IX)

wherein T and R are defined as described above in formulas (I) and (V).

Examples of specific aromatic bis(ether anhydride)s and organic diamines are disclosed, for example, in U.S. Pat. Nos. 3,972,902 and 4,455,410. Illustrative examples of aromatic bis(ether anhydride)s of formula (VIII) include: 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s can be prepared by the hydrolysis, followed by dehydration, of the reaction product of a nitro substituted phenyl dinitrile with a metal salt of dihydric phenol compound in the presence of a dipolar, aprotic solvent. A preferred class of aromatic bis(ether anhydride)s encompassed by formula (VIII) above includes, but is not limited to, compounds wherein T is of the formula (X)

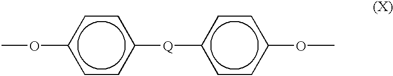

and the ether linkages, for example, are preferably in the 3,3′, 3,4′, 4,3′, or 4,4′ positions, and mixtures thereof, and where Q is as defined above.

Any diamino compound may be employed in the method of this invention. Examples of suitable compounds are ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylenediamine, 5-methyl-4,6-diethyl-1,3-phenylenediamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(b-amino-t-butyl) toluene, bis(p-b-amino-t-butylphenyl) ether, bis(p-b-methyl-o-aminophenyl) benzene, bis(p-b-methyl-o-aminopentyl) benzene, 1, 3-diamino-4-isopropylbenzene, bis(4-aminophenyl) sulfide, bis (4-aminophenyl) sulfone, bis(4-aminophenyl) ether and 1,3-bis(3-aminopropyl) tetramethyldisiloxane. Mixtures of these compounds may also be present. The preferred diamino compounds are aromatic diamines, especially m- and p-phenylenediamine and mixtures thereof.

In a particularly preferred embodiment, the polyetherimide resin comprises structural units according to formula (V) wherein each R is independently p-phenylene or m-phenylene or a mixture thereof and T is a divalent radical of the formula (XI)

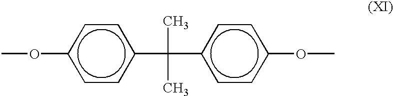

Included among the many methods of making the polyimides, particularly polyetherimides, are those disclosed in U.S. Pat. Nos. 3,847,867, 3,814,869, 3,850,885, 3,852,242, 3,855,178, 3,983,093, and 4,443,591.

In general, the reactions can be carried out employing well-known solvents, e.g., o-dichlorobenzene, m-cresol/toluene and the like, to effect a reaction between the anhydride of formula (VIII) and the diamine of formula (IX), at temperatures of about 100° C. to about 250° C. Alternatively, the polyetherimide can be prepared by melt polymerization of aromatic bis(ether anhydride)s (VIII) and diamines (IX) by heating a mixture of the starting materials to elevated temperatures with concurrent stirring. Generally, melt polymerizations employ temperatures of about 200° C. to about 400° C. Chain stoppers and branching agents may also be employed in the reaction. When polyetherimide/polyimide copolymers are employed, a dianhydride, such as pyromellitic anhydride, is typically used in combination with the bis(ether anhydride). The polyetherimide resins can optionally be prepared from reaction of an aromatic bis(ether anhydride) with an organic diamine in which the diamine is present in the reaction mixture at no more than about 0.2 molar excess, and preferably less than about 0.2 molar excess.

Under such conditions the polyetherimide resin has less than about 15 microequivalents per gram (μeq/g) acid titratable groups, and preferably less than about 10 μeq/g acid titratable groups, as shown by titration in chloroform solution with a solution of 33 weight percent (wt %) hydrobromic acid in glacial acetic acid. Acid-titratable groups are essentially due to amine end-groups in the polyetherimide resin.

Generally, useful polyetherimides have a melt index of about 0.1 to about 10 grams per minute (“g/min”), as measured by American Society for Testing Materials (“ASTM”) D1238 at 337° C., using a 6.6 kilogram (“kg”) weight. In a preferred embodiment, the polyetherimide resin has a weight average molecular weight (Mw) of about 10,000 to about 150,000 grams per mole (“g/mole”), as measured by gel permeation chromatography, using a polystyrene standard. Such polyetherimide resins typically have an intrinsic viscosity [η] greater than about 0.2 deciliters per gram, preferably about 0.35 to about 0.7 deciliters per gram measured in m-cresol at 25° C. Some such polyetherimides include, but are not limited to those sold by GE Plastics under the trademark ULTEM and include Ultem 1000 (number average molecular weight (Mn) about 21,000; weight average molecular weight (Mw) about 54,000; dispersity about 2.5), Ultem 1010 (Mn about 19,000; Mw about 47,000; dispersity about 2.5), Ultem 1040 (Mn about 12,000; Mw 34,000-35,000; dispersity about 2.9), or mixtures thereof.

A number of second thermoplastic polymers (b) are suitable for blending with the thermoplastic polyimide resin, particularly polyetherimide resin, including but not limited to polycarbonate esters, epoxy-functionalized polyolefins, poly(tetrafluoroethylene)s, polyetherimide-siloxane copolymers, polyarylates, polyester carbonates, polysulfones, poly(ether sulfone)s, polyphenylene ethers, polyamides, and polyesters and combinations of the foregoing. The second resin also may include chemically modified or functionalized resin of the foregoing to enhance the compatibility of the second resin with the thermoplastic polyimide resin. The total amount of second polymer resin (b) present in the composition is in the range from about 5 to about 95%, preferably from about 15 to about 85%, and most preferably from about 25 to about 75% by weight, based on combined weight of components (a) and (b).

Polyesters are illustrated by poly(alkylene dicarboxylates), especially poly(ethylene terephthalate) (hereinafter sometimes designated “PET”), poly(1,4-butylene terephthalate) (hereinafter sometimes designated “PBT”), poly(trimethylene terephthalate) (hereinafter sometimes designated “PTT”), poly(ethylene naphthalate) (hereinafter sometimes designated “PEN”), poly(1,4-butylene naphthalate) (hereinafter sometimes designated “PBN”), poly(cyclohexanedimethanol terephthalate) (hereinafter sometimes designated “PCT”), poly(cyclohexanedimethanol-co-ethylene terephthalate) (hereinafter sometimes designated “PETG”), and poly(1,4-cyclohexanedimethyl-1,4-cyclohexanedicarboxylate) (hereinafter sometimes designated “PCCD”), and especially poly(alkylene arenedioates), with poly(ethylene terephthalate) and poly(1,4-butylene terephthalate) being preferred. Mixtures of poly(alkylene dicarboxylates) may also be employed. Polyarylates include those with structural units comprising the 1,3-dihydroxybenzene moiety present in the arylate blocks of the copolyestercarbonates, those with structural units comprising any organic dihydroxy compound added in the carbonate block formation step in synthesis of said copolyestercarbonates, and those with structural units comprising both of the aforementioned dihydroxy moieties. Illustrative examples include polyarylates comprising terephthalate and/or isophthalate structural units in combination with structural units derived from one or more of unsubstituted resorcinol, substituted resorcinol, and bisphenol A.

A preferred thermoplastic second polymer (b) is a polycarbonate ester (referred to hereinafter as “PCE”). PCE comprises repeating polycarbonate chain units of the formula (XII):

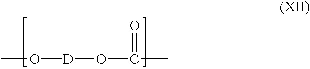

and recurring carboxylic chain units of the formula (XIII):

—O—R¹—O—D— (XIII)

wherein each D is independently a divalent aromatic radical of a dihydric phenol employed in the resin preparation and R1 is a divalent moiety selected from those of the formulae (XIV) or (XV) and the corresponding naphthalene derivatives, for example naphthalene-2,6-dicarboxylate, or mixtures thereof:

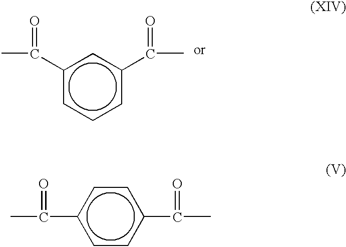

The PCE may be prepared by such methods as melt polymerization or interfacial polymerization. Melt polymerization involves co-reacting, for example, diphenyl carbonate with various mixtures of dihydric phenols and ester precursors such as, for example, diphenyl derivatives of isophthalates and terephthalates, and their mixtures. Various catalysts or mixtures of catalysts such as, for example, lithium hydroxide and lithium stearate can also be used to accelerate the polymerization reactions. In general, the method of interfacial polymerization comprises the reaction of a dihydric phenol with a carbonate precursor in the presence of an ester precursor. Examples of interfacial polymerization techniques can be found in U.S. Pat. Nos. 3,169,121 and 4,487,896.

Although the reaction conditions of the preparative processes may vary, several of the preferred processes typically involve dissolving or dispersing dihydric phenol and ester precursor reactants in aqueous caustic, combining the resulting mixture with a suitable water immiscible solvent medium and contacting the reactants with the carbonate precursor, such as, for example, phosgene, in the presence of a suitable catalyst and under controlled pH conditions. The catalyst typically accelerates the rate of polymerization of the dihydric phenol and ester precursor reactants with the carbonate precursors. Representative catalysts include but are not limited to, for example, tertiary amines such as triethylamine, quaternary phosphonium compounds, quaternary ammonium compounds, and the like. A preferred reaction is the phosgenation reaction.

The dihydric phenols employed are known, and the reactive groups are thought to be the phenolic hydroxyl groups. Some of the dihydric phenols are represented by the general formula (XVI):

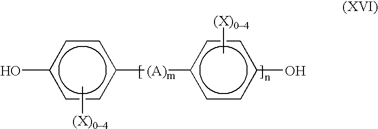

wherein A is selected from the group consisting of a divalent hydrocarbon radical containing from 1 to about 15 carbon atoms, a substituted divalent hydrocarbon radical containing from 1 to about 15 carbon atoms and substituent groups such as halogen, and —C(O)—; —S—; —SS—; —S(O)₂—; —O—; or —S(O)—; each X is independently selected from the group consisting of hydrogen, halogen, and a monovalent hydrocarbon radical such as an alkyl group of from 1 to about 8 carbon atoms, an aryl group of from 6 to about 18 carbon atoms, an aralkyl group of from 7 to 14 carbon atoms, an alkaryl group of from 7 to about 14 carbon atoms, and an alkoxy group of from 1 to about 8 carbon atoms; and m is 0 or 1 and n is an integer of from 0 to about 5.

Typical of some of the dihydric phenols employed are bis-phenols such as (4-hydroxyphenyl)methane, 2,2-bis(4-hydroxyphenyl)propane (also know at bisphenol-A), 2,2-bis(4-hydroxy-3,5-dibromo-phenyl)propane; dihydric phenol ethers such as bis(4-hydroxyphenyl)ether, bis(3,5-dichloro-4-hydroxyphenyl)ether; bis (3, 5-dibromo-4-hydroxyphenyl) ether; dihydroxydiphenyls such as p,p′-dihydroxydiphenyl, 3,3′-dichloro-4,4′-dihydroxydiphenyl; dihydroxyaryl sulfones such as bis(4-hydroxyphenyl)sulfones, bis(3,5-dimethyl-4-hydroxyphenyl) sulfones, dihydroxy benzenes such as resorcinol, hydroquinone, halo- and alkyl-substituted dihydroxybenzenes such as 1,4-dihydroxy-2,5-dichlorobenzene, 1,4-dihydroxy-3-methylbenzene; and dihydroxydiphenyl sulfides and sulfoxides such as bis(4-hydroxyphenyl) sulfide, bis(4-hydroxy-phenyl)sulfoxide and bis(3,5-dibromo-4-hydroxy-phenyl)sulfoxide. A variety of additional dihydroxy-substituted aromatic hydrocarbons disclosed by name or formula (generic or specific) are available and are disclosed in U.S. Pat. No. 4,217,438. It is, of course, possible to employ two or more different dihydric phenols or a combination of a dihydric phenol with a glycol.

The carbonate precursors are typically a carbonyl halide, a diarylcarbonate, or a bishaloformate. The carbonyl halides include, for example, carbonyl bromide, carbonyl chloride, and mixtures thereof. The bishaloformates include the bishaloformates of dihydric phenols such as bischloroformates of 2,2-bis(4-hydroxy-3,5-dichlorophenyl)propane, hydroquinone, and the like, or bishaloformates of glycol, and the like. While all of the above carbonate precursors are useful, carbonyl chloride, also known as phosgene, is preferred.

In general, any dicarboxylic acid conventionally used in the preparation of polyesters may be utilized in the preparation of PCE resins. However, a preferred PCE is prepared with aromatic dicarboxylic acids, and in particular terephthalic acid, and mixtures thereof with isophthalic acid. Suitable weight ratios of terephthalic acid to isophthalic acid are in the range of from about 2:98 to about 98:2. Preferred weight ratios of terephthalic acid to isophthalic acid are in the range of from about 2:98 to about 98:2, especially preferred are weight ratios of terephthalic acid to isophthalic acid in the range of from about 40:60 to about 60:40.

Rather that utilizing the dicarboxylic acid per se, it is possible, and sometimes even preferred, to employ various derivatives of the acid moiety. Illustrative of these reactive derivatives are the acid halides. The preferred acid halides are the acid dichlorides and the acid dibromides. Thus, for example, instead of using terephthalic acid or mixtures thereof with isophthalic acid, it is possible to employ terephthaloyl dichloride, and mixtures thereof with isophthaloyl dichloride and vice versa.

In the conventional interfacial polymerization methods of preparing PCE, polycarbonates and polyarylates, a molecular weight regulator (a chain stopper) is generally added to the reaction mixture prior to or during the polymerization reactions with carbonate and/or ester precursors. Useful molecular weight regulators include, for example, monohydric phenols such as phenol, chroman-I, para-t-butylphenol, p-cumylphenol and the like.

The proportions of reactants employed to prepare the PCE will vary in accordance with the proposed use of the blends of the invention containing this product resin. In general, the amount of the combined ester units of terephthalate and isophthalate may be from about 20% by weight to about 85% by weight, relative to the carbonate units, preferably about 40% to about 80% by weight relative to the carbonate units.

The preferred PCE for use as the ingredient (b) in the blends of the present invention are those derived from reaction of bisphenol-A and phosgene with iso- and terephthaloyl dichloride and having a weight average molecular weight of between about 25,000 and about 40,000 relative to polystyrene standards as determined by gel permeation chromatography. For enhancing the lipid resistance of the present compositions, an especially preferred PCE has a weight average molecular weight of at least about 30,000 and preferably at least about 34,000 (relative to polystyrene standards as determined by gel permeation chromatography).

The PCE is generally present in amounts in the range from about 5 to about 95%, preferably from about 15 to about 85%, and most preferably from about 25 to about 75% by weight based on the total weight of the polyimide and PCE and any additional second resin of the composition.

Other preferred second, thermoplastic polymers (b) include epoxy-functionalized polyolefins, for example epoxy-functionalized polyethylenes, polypropylenes, polyisoprenes, polybutylenes, and copolymers thereof. Epoxy-functionalized terpolymers of olefins and at least two acrylate monomers are also suitable. Preferred epoxy-functionalized polyolefins and terpolymers of ethylene, glycidyl methacrylate, and an alkyl acrylate such as methylacrylate, include copolymers of ethylene and glycidyl methacrylate, and have epoxy groups present in an amount in the range from about 3 wt. % to about 18 wt. %, and preferably from about 5 wt. % to about 13 wt. %. These polymers are available from Sumitomo Chemical Co. under the name “BONDFAST” or “IGETABOND”, including BONDFAST E, which comprises 12 wt. % glycidyl methacrylate, BONDFAST 2C, which comprises 6 wt. % glycidyl methacrylate, or from Elf Atochem under the trade name “LOTADER”, including LOTADER AX8840, which comprises 8 wt. % glycidyl methacrylate.

The epoxy-functionalized polyolefin is generally present in amounts in the range from about 1 to about 20%, preferably from about 1 to about 10%, and most preferably from about 2 to about 6% by weight of resinous components.

Still other preferred thermoplastic second polymers include poly(tetrafluoroethylene) (“PTFE”) which contributes to wear resistance. PTFE is generally present in amounts in the range from about 0.3 to about 20%, preferably from about 0.5 to about 10%, and most preferably from about 1 to about 5% by weight based on the weight of the total composition. Preferred PTFE particle sizes are in the range of about 1-30 microns.

Still other preferred thermoplastic second polymers include, but are not limited to, random copolymers formed from polyetherimides and siloxanes (hereinafter sometimes referred to as polyetherimide-siloxane copolymer), and having the general structure (V) wherein at least a portion of the R groups have the structure (XVIII):

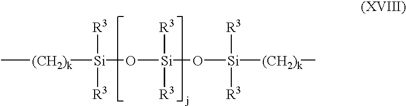

wherein R³ is a monovalent hydrocarbon radical having from 1 to 10 carbon atoms, and is preferably methyl, k is an integer from 1 to about 8, and j is an integer in the range from 0 to about 100. Synthesis of such random copolymers are disclosed, for example, in U.S. Pat. Nos. 3,833,546 and 3,847,867. The compositions comprise at least one poly(diorganosiloxane), component (c). Poly(diorganosiloxane)s usually consist essentially of a main chain of alternating silicon atoms and oxygen atoms, substituted with various organic groups at the silicon atom. A broad variety of poly(diorganosiloxane)s are suitable for use in the molding compositions, including homopolymers, and block or random copolymers. Preferred poly(diorganosiloxane)s have the structure:

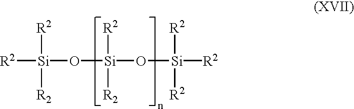

wherein each R² independently represents hydrogen, C₁₋₁₅ alkyl, C₂₋₁₀ alkenyl, C₅₋₁₂ cycloalkyl, C₆₋₁₂ aryl, or C₇₋₁₈ alkaryl, which groups may be halogenated, particularly fluorinated, and wherein n is such that the compound has a nominal weight average molecular weight of from about 100,000 to about 1,500,000 grams/mole. A preferred poly(diorganosiloxane) is one derived from poly(dimethylsiloxane). In a more preferred embodiment, the poly(diorganosiloxane) has a nominal weight average molecular weight of about 800,000.

The poly(diorganosiloxane)s may be manufactured according to conventional methods and many are commercially available, e.g., from GE Silicones, Dow Corning, etc. Preferred poly(diorganosiloxane)s have a penetration value of about 800 mm or less. Particularly preferred poly(diorganosiloxane)s include GE Silicones grade 88488-8 which is an 800 mm penetration poly(dimethylsiloxane) gum containing vinyl groups on the chain ends and the backbone. The general formula of 88488-8 gum is M^{Vi}_{-D}ₓD^{Vi}y-M^{Vi} and it contains about 0.25 mole % Vi groups. In another embodiment the poly(diorganosiloxane) is GE Silicones grade 81366-8 which is an 800 mm penetration poly(dimethylsiloxane) gum of the general formula MDxM. In all cases penetratuion values are measured using a penetrometer with 100 gram weight at a sample temperature of 25° C. wherein the test is timed and terminated either after the plunger reaches 300 millimeters or when the test has run for 60 seconds and the penetration value is calculated using the equation (plunger reading divided by time) multiplied by 60 seconds.

A poly(diorganosiloxane) may optionally contain an inorganic filler component. Suitable fillers include silica, alumina, titania, Wollastonite, calcium silicate, carbon black, calcium carbonate, clays, kaolin, aluminum silicate, bentonite, montmorillonite, talc, synthetic magnesium silicate, zeolites, zinc oxide, barium sulfate, calcium sulfate, wood flour, wood cellulose, or mixtures thereof. The fillers may be calcined and/or surface treated and/or intercalated with an organic additive as appropriate to improve the final properties of the filler-containing compositions. A particularly preferred filler component is a precipitated silica or a fumed silica, preferably a silane-treated fumed silica. Most preferably the filler component is a D₄ (octamethylcyclotetrasiloxane)-treated fumed silica. When present, said fumed silica is used with at least one poly(diorganosiloxane) in an amount of from about 30 to about 100 parts by weight based on the weight of the poly(diorganosiloxane), most preferably from about 60 to about 70 parts by weight.

The amount of poly(diorganosiloxane) (c) present in the compositions is a minor proportion, effective to improve physical properties of the polyimide molding composition. Preferably, the poly(diorganosiloxane) is present at a level of about 0.1-10%, more preferably about 0.2-8%, still more preferably about 0.3-6%, and yet still more preferably about 0.4-6% by weight of the entire composition. In especially preferred embodiments the poly(diorganosiloxane) is present in the composition at a level of about 0.4-3% by weight of the entire composition. An effective amount of poly(diorganosiloxane) is that which improves the physical properties, particularly low temperature (that is, at 0° C. or less) impact strength, or surface appearance of molded parts compared to molded parts of the corresponding composition without poly(diorganosiloxane). Improvements in surface appearance may be discerned by those skilled in the art and include improvement in gloss and diminution or elimination of gate blush, delamination, shark-skinning etc.

The poly(diorganosiloxane), component (c), may be added to the blends by any one of several different processes. Because suitable poly(diorganosiloxane)s are typically high-viscosity gums, they generally are not readily combined with other blend ingredients in a container such as a feed hopper of an extruder. To solve this problem, a poly(diorganosiloxane)s may be dispersed within a matrix of at least one polyimide (a) or of at least one second thermoplastic component (b) different from any polyimide to produce a free-flowing powder concentrate. Related concentrates are described, for example, in commonly assigned U.S. Pat. No. 6,194,518. Preferably, the concentrates comprise from about 1% to about 60% by weight of poly(diorganosiloxane)s based on the total weight of the concentrate. In one embodiment the matrix may be a mixture of polyetherimides (a), or a mixture of more than one second thermoplastic component (b). The resins may each be present in the form of a single molecular weight grade or a mixture of different molecular weight grades. In another embodiment the matrix may be in the form of a mixture of at least one polyetherimide component (a) with at least one second thermoplastic component (b), as long as at least one component is substantially present as a high surface area powder. Resins which are not supplied in the form of free-flowing powders may be converted to such powders by known methods, such as by cooling in liquid nitrogen and grinding to a high surface-area powder using a mechanical grinder fitted with a particle screen, e.g., 1 mm.

Alternatively, a poly(diorganosiloxane) may be pre-dispersed in an inorganic matrix such as a very high surface area (about 200 m²/g) fumed silica to form a free-flowing powder. Such powders generally comprise from about 40% to about 80%, and preferably from about 50% to about 70% poly(diorganosiloxane) by weight. Alternative high-surface-area inorganic matrices include titania, alumina, Wollastonite, clays (e.g., bentonite, kaolin, montmorillonite, and the like), zeolites, barium sulfate, carbon black, and the like. This pre-dispersed mixture may be added directly to the blend components, or it may be used to form a concentrate with at least one polyimide component (a), at least one thermoplastic polymer component (b), or a mixture thereof as described above.

Dispersion is most effectively carried out using high speed mixing equipment such as a Henschel-type mixer, although other mixing devices such as tumble mixers and ribbon mixers may also be utilized. Processes for dispersion of poly(diorganosiloxane)-containing gum in appropriate, high-surface-area matrices are described, for example, in U.S. Pat. Nos. 3,824,208 and 5,153,238.

The dispersed poly(diorganosiloxane) is thus obtained in the form of a free-flowing powder concentrate in either a thermoplastic matrix, an inorganic matrix, or a mixture of thermoplastic and inorganic matrices. This powder may be mixed with other resinous and non-resinous blend ingredients using an appropriate mixing method to form free-flowing compositions suitable for use in a compounding process such as extrusion. Less preferably, a high viscosity poly(diorganosiloxane) itself may be combined for dispersion with all of the other blend ingredients in a suitable mixer such as a Henschel mixer provided that some portion of the mixture consists of a high surface area powder.

The components used to form the matrix for the concentrate may constitute all or a portion of that material in the final blend. For example, where thermoplastic polyimide powder is used as the matrix, then either all or only a portion of the polyimide may be added to the blend in the form of a pre-dispersed concentrate with a poly(diorganosiloxane). Preferably, only a portion of the total polyimide is added in the form of a concentrate and the remaining polyimide is added separately in the form of pellets or powder. Where only a portion of the resins (a) or (b) is added in the form of the concentrate, it is not necessary that the resin in the concentrate have the same physical characteristics as the resin added separately. For example, one molecular weight grade or type of polyimide (a) or second polymer (b) may be used to form the concentrate, and a second molecular weight grade or type may be used for the remainder of the blend.

Optional components (d) in the compositions include but are not limited to pigments (such as titanium dioxide and carbon black), reinforcing agents (for example, glass fibers, carbon fibers and fibrils), fillers (for example, clay, mica, or talc), flow promoters and other processing aids, mold release agents, lubricants, viscosity modifiers, heat stabilizers, flame retardants, and the like.

To form blends comprising the above-described components, the combined components are preferably melt-compounded in an extruder to form an intimately mixed blend. The pellets produced by extrusion are suitable for shaping into useful forms by injection molding, thermoforming, blow molding, and the like. In one exemplary process, a poly(diorganosiloxane) concentrate and the other blend components are fed into the feed hopper of an extruder. Alternatively, a poly(diorganosiloxane) concentrate and at least a portion of the other blend ingredients are fed into an initial extruder feedport, while the remaining portion of the blend ingredients is fed to the extruder at a second feedport downstream of an initial extruder feedport. In another process, all or a portion of the poly(diorganosiloxane) concentrate, and none or a portion of the other blend components are fed at a feedport downstream of an initial feedthroat, while the remaining blend ingredients are fed to an initial feedport. Optionally, either or both extruder feedports may be followed by an extruder barrel segment equipped with a vacuum vent for removal of any volatile by-products.

The invention is further illustrated by the following non-limiting examples. All parts are parts by weight unless indicated otherwise. Mixing was accomplished in a Henschel mixer. The following materials were used:

Poly(diorganosiloxane) gum (GUM): GES grade 88488-8, available from General Electric Company;

Polycarbonate ester (PCE) resin having about 60% ester units (derived from about a 1:1 ratio of isophthalic acid to terephthalic acid) relative to carbonate units and having a weight average molecular weight of about 28,000 (relative to polystyrene standards as determined by gel permeation chromatography) available from GE Plastics;

Polyetherimide (PEI) resins made by condensation of meta-phenylene diamine with 2, 2-bis[4-(3,4-dicarboxyphenoxy)phenyl]propane dianhydride and having a melt index of either 1.8 g/min at 337° C. (PEI-1); or having a melt index of about 0.9 g/min. at 337° C. (PEI-2); or having a melt index of about 4.6 g/min. at 337° C. (PEI-3) (available from GE Plastics), An polyetherimide-siloxane random copolymer containing structural units derived from meta-phenylene diamine, 2, 2-bis[4-(3,4-dicarboxyphenoxy)phenyl]propane dianhydride, and a poly(dimethylsiloxane) of the formula (XVIII) wherein k is 3 and j is about 10 (SILTEM from GE Plastics).

Copolymers of ethylene and glycidyl methacrylate comprising about 12 wt. % glycidyl methacrylate from Sumitomo Chemical Co. under the name BONDFAST E (BFE).

Poly(tetrafluoroethylene) from Sumitomo Chemical Co. under the trade name SP1010.

Molded test parts were equilibrated overnight at 23° C. and 50% humidity before testing. Notched and reverse notched Izod impact values were determined as described in ASTM #D256. Tensile properties were determined as described in ASTM #D638. All parts in the following examples are parts by weight.

### EXAMPLE 1

Two concentrates of GUM in a PCE matrix were prepared in a Henschel mixer by blending gum with PCE powder until the gum was intimately dispersed. Concentrate A comprised 9.1% gum in PCE (from 100 g. GUM mixed with 1000 g. PCE) and concentrate B comprised 16.7% gum in PCE (from 200 g. GUM mixed with 1000 g. PCE).

Table 1 shows the results from blends prepared by mixing and extruding the compositions as shown. Blends were extruded using a twin-screw extruder operated with barrel set temperatures of about 320° C. The extruder was vacuum-vented at the fifth barrel segment. Blends were molded on a molder with barrel set temperatures 335, 335, 332, and 321° C. (back zone); 111/107° C. (movable/stationary sides) mold set temperatures; and 26.5 second cycle time.

TABLE 1

| | | | | | Notched | Tensile | |
|---|---|---|---|---|---|---|---|
| | | | | | Izod | strength | Elong. |
| No. | PEI-1 | PCE | GUM | Conc. | (ft-lb/in) | (psi) | (%) |
| 1* | 75 | 25 | — | — | 0.36 | 13690 | 13 ± 4 |
| 2 | 73.2 | 24.4 | 2.4 | A | 1.21 | 13430 | 19 ± 1 |
| 3 | 71.4 | 23.8 | 5 | B | 0.91 | 12930 | 16 ± 4 |

*Control

As the results in Table 1 show, the blends containing GUM have higher impact strength than the control blend. No significant change in the impact strength was seen between 2.4 to 5 parts added GUM. Tensile properties were not significantly improved at any loading of GUM compared to the control blend. The control blend extruded with surging, while Samples 2 and 3 extruded smoothly and with higher throughput rate indicating improved processability for the new blends.

### EXAMPLE 2

A premix of 62 parts GUM and 38 parts fumed silica was prepared in a Henschel mixer. The free-flowing premix (161 g) was then combined with PCE powder (1000 g) in a Henschel mixer by mixing until the premix was intimately dispersed to give a new concentrate, C, comprising 8.6% gum. Table 2 shows blends prepared by mixing and extruding the compositions as shown, using the methods described in Example 1.

TABLE 2

| | | | | | Notched | Reverse | | |
|---|---|---|---|---|---|---|---|---|
| | | | | | Izod | Izod | Tensile | |
| | | | | | (ft- | (ft- | strength | Elong. |
| No. | PEI-1 | PCE | GUM | Silica | lb/in) | lb/in) | (psi) | (%) |
| 4* | 75 | 25 | — | — | 0.36 | N.B.** | 13690 | 13 ± 4 |
| 5 | 72 | 24 | 2.4 | 1.5 | 0.70 | N.B. | 13580 | 26 ± 4 |

*Control
**N.B. = no break

Sample 5, which contains GUM, has a higher impact strength and higher tensile elongation than the control blend. The control blend extruded with surging, while Sample 5 extruded smoothly, indicating improved processability for the Sample 5. The molded parts exhibited very good surface appearance, and no delamination was observed in parts broken by hand.

### EXAMPLE 3

The compositions in Table 3 were prepared by simultaneously mixing PEI, PCE, carbon black, and GUM as shown, together with 0.4 parts of conventional additives including a phosphite stabilizer. Blends were extruded using a co-rotating, twin-screw extruder with barrel set temperatures of about 300° C. Blends were molded on a molder with barrel temperatures of 318, 318, 318, and 315° C. (back zone); and the mold set temperatures of 127/121° C. (movable/stationary sides).

TABLE 3

| | | | | | Notched |
|---|---|---|---|---|---|
| | | | Carbon | | Izod |
| No. | PEI-1 | PCE | Black | GUM | (ft-lb/in.) |
| 6* | 15 | 85 | 0.3 | — | 4.1 ± 3.6 |
| 7* | 15 | 85 | 0.6 | — | 3.4 ± 3.5 |
| 8* | 15 | 85 | 0.9 | — | 5.1 ± 3.6 |
| 9 | 15 | 85 | 0.3 | 0.5 | 4.7 ± 4.0 |
| 10 | 15 | 85 | 0.6 | 0.5 | 6.3 ± 3.9 |
| 11 | 15 | 85 | 0.9 | 0.5 | 4.8 ± 1.1 |
| 12 | 15 | 85 | 0.3 | 1.5 | 9.9 ± 0.5 |
| 13 | 15 | 85 | 0.6 | 1.5 | 9.7 ± 0.4 |
| 14 | 15 | 85 | 0.9 | 1.5 | 9.3 ± 1.1 |

*Control

These data show that addition of GUM at 1.5 parts loading results in marked increase and less variability in impact strength.

### EXAMPLE 4

A premix was prepared in a Henschel mixer from 62 parts GUM and 38 parts fumed silica. Blends were prepared by mixing PEI, PCE, carbon black, together with 0.4 parts of conventional additives including a phosphite stabilizer, and the premix where indicated to yield the compositions shown in Table 4. The blends were extruded and molded into test parts as described in Example 3.

TABLE 4

| | | | | | | Notched | | |
|---|---|---|---|---|---|---|---|---|
| | | | Carbon | | | Izod | Tensile | Elong. |
| No. | PEI-1 | PCE | Black | GUM | Silica | (ft-lb/in) | strength (psi) | (%) |
| 15* | 15 | 85 | 0.3 | — | — | 4.1 ± 3.6 | 10170 | 73 ± 19 |
| 16* | 15 | 85 | 0.6 | — | — | 3.4 ± 3.5 | 10130 | 86 ± 33 |
| 17* | 15 | 85 | 0.9 | — | — | 5.1 ± 3.6 | 10240 | 53 ± 11 |
| 18 | 15 | 85 | 0.3 | 1.3 | 0.8 | 11.0 ± 0.5 | 9889 | 118 ± 42 |
| 19 | 15 | 85 | 0.6 | 1.3 | 0.8 | 10.8 ± 0.8 | 10290 | 154 ± 27 |
| 20 | 15 | 85 | 0.9 | 1.3 | 0.8 | 9.4 ± 2.2 | 9884 | 118 ± 29 |

*Control

The data show that addition of 1.3 parts GUM and 0.8 parts fumed silica results in marked increase in both impact strength and in tensile elongation, and less variability in impact strength.

### EXAMPLE 5

A premix was prepared in a Henschel mixer from 62 parts GUM and 38 parts fumed silica. Blends were prepared by mixing PEI, PCE, 0.3 parts carbon black, together with 0.4 parts of conventional additives including a phosphite stabilizer, and the premix where indicated to yield the compositions shown in Table 5. Blends were extruded using a twin-screw extruder with barrel set temperatures of about 315° C. The extruder was vacuum-vented at the fifth barrel segment. Samples were molded as described in Example 4.

TABLE 5

| | | | | Fum- | Notched | Reverse | | |
|---|---|---|---|---|---|---|---|---|
| | | | | ed | Izod | Izod | Tensile | |
| | | | | sil- | (ft- | (ft- | strength | Elong. |
| No. | PEI-1 | PCE | GUM | ica | lb/in) | lb/in) | (psi) | (%) |
| 21* | 15 | 85 | — | — | 6.2 | 38.9 | 9180 | 58 |
| 22 | 15 | 85 | 0.93 | 0.48 | 9.8 | 39.9 | 10200 | 84 |
| 23 | 15 | 85 | 1.86 | 0.96 | 8.6 | 39.1 | 10400 | 89 |

*Control

The data show that addition of only 0.93 parts GUM and 0.48 parts fumed silica results in marked increase in both impact strength and in tensile elongation. No further improvement in properties was seen with addition of twice as much GUM-fumed silica premix. The surface appearance of the molded parts containing GUM and fumed silica was clearly better than that for molded parts made without these additives.

### EXAMPLE 6

Concentrate D (10% GUM) was prepared by mixing GUM (100 g) with PEI-1 (900 g). Concentrate E (9.4% GUM) was formed by blending 161 g of a premix comprising GUM (62 g) and fumed silica (38 g) with 900 g of PEI-1. Blends containing these concentrates were prepared with a mixture of PEI-2 and PEI-3 in the ratios indicated. Blends were prepared by mixing the two PEI resins, BFE, and concentrates (containing the third PEI resin) as indicated to yield the compositions shown in Table 6 in parts by weight of the total composition. Blends were extruded using a twin-screw extruder operated with barrel set temperatures of about 330° C. without vacuum venting. Blends were molded on a molder with barrel set temperatures of 335, 335, 332, and 321° C. (back zone); 111/107° C. (movable/stationary sides) mold set temperatures; and 26.5 second cycle time

TABLE 6

| | | | | | | Notched | | | |
|---|---|---|---|---|---|---|---|---|---|
| | | | | | | Izod | Reverse | Tensile | |
| | PEI-2/ | | | Fumed | | (ft- | Izod | strength | Elong. |
| No. | PEI-3/PEI-1 | BFE | GUM | Silica | Conc. | lb/in) | (ft-lb/in) | (psi) | (%) |
| 24* | 74.6/20.4/0 | 5 | — | — | — | 1.4 ± 0.4 | N.B.** | 13920 | 24 ± 5 |
| 25 | 66.7/18.3/9 | 5 | 1 | — | D | 3.0 ± 0.1 | N.B. | 13100 | 23 ± 2 |
| 26 | 62.9/17.2/13.6 | 5 | 0.9 | 0.6 | E | 3.3 ± 0.6 | N.B. | 12720 | 43 ± 15 |

*Control
**N.B. = no break

The data show that addition of GUM at 1 part loading results in an increase in impact strength. The sample containing both GUM and fumed silica shows an increase in both impact strength and in tensile elongation. The control blend extruded with some surging, while the test blends extruded smoothly, indicating improved processability for the test blends. The molded parts exhibited very good surface appearance. No delamination was observed in parts broken by hand.

### EXAMPLE 7

Samples comprising PEI, PTFE, BFE, poly(diorganosiloxane) gum, or polyetherimide-siloxane copolymer as shown in Table 7 (percent by weight) were blended and molded into test pieces, then tested for notched Izod impact strength, wear, and coefficient of friction (COF). Each sample contained a mixture of PEI-2 and PEI-3 in a ratio of 79: 21. Gum was added as a 20% concentrate in PEI. All samples (with the exception of control No. 27) contained less than 2 wt. % additives such as titanium dioxide pigment and phosphorus-containing heat stabilizers which are not believed to have a significant effect on the reported properties. Sample 29 was compounded in a single extrusion pass while sample 30 was compounded in two extrusion passes with BFE being adding in the second pass. Wear factor (K; in units of cubic inches-minutes per foot per pound per hour determined through periodic measurements during 80 hours test duration), static COF, and dynamic COF were determined using a thrust washer test apparatus with sample thrust washer mounted in an antifriction bearing equipped with a torque arm at a pressure of 40 psi and a velocity of 50 feet per minute. Results are shown in Table 7.

TABLE 7

| | | | | | | Notched | | | |
|---|---|---|---|---|---|---|---|---|---|
| | PEI | | | | | Izod | Wear | Static | Dynamic |
| No. | mix | PTFE | BFE | GUM | SILTEM | (ft-lb/in) | Factor | COF | COF |
| 27* | 100 | — | — | — | — | 0.8 | 11,000 | 0.41 | 0.50 |
| 28* | 83.8 | 10 | 5 | — | — | 5.8 | 750 | 0.35 | 0.34 |
| 29* | 84.5 | 9.5 | 4.8 | — | — | 5.2 | 951 | 0.13 | 0.30 |
| 30 | 83.8 | 10 | 5 | — | 1.0 | — | 373 | 0.15 | 0.32 |
| 31 | 83.3 | 9.6 | 4.8 | 1.1 | — | — | 363 | 0.08 | 0.21 |

*Control

As the results in Table 7 show, the blends containing PTFE alone (Samples 29 and 30) show significantly better wear resistance than neat PEI. The blends comprising a poly(diorganosiloxane) (Samples 31 and 32) demonstrate greatly improved coefficient of static friction, while the blend comprising the gum (Sample 31) shows the best dynamic coefficient of friction. These compositions are accordingly useful for applications such as scraper blades for kettles, wear strips, filler nozzles, and other food and non-food related applications.

While preferred embodiments have been shown and described, various modifications and substitutions may be made thereto without departing from the spirit and scope of the invention. Accordingly, it is to be understood that the present invention has been described by way of illustration and not limitation. All of the U.S. Patent cited herein are incorporated herein by reference.

What is claimed is:

1. A polyimide molding composition comprising:
(a) at least one thermoplastic polyimide resin;
(b) at least one second thermoplastic resin which is chemically distinct from any polyimide resin; and
(c) a poly(diorganosiloxane).

2. The composition of claim 1, wherein a polyimide resin (a) comprises repeat units of the formula 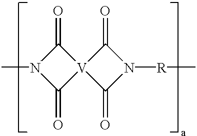
wherein a is an integer from about 10 to about 10,000; V is a tetravalent linker selected from the group consisting of substituted and unsubstituted, saturated, unsaturated and aromatic monocyclic and polycyclic groups having about 5 to about 50 carbon atoms, substituted and unsubstituted, linear and branched, saturated and unsaturated alkyl groups having 1 to about 30 carbon atoms; and combinations thereof; and R is selected from the group consisting of aromatic hydrocarbon radicals having about 6 to about 20 carbon atoms and halogenated derivatives thereof; straight and branched chain alkylene radicals having about 2 to about 20 carbon atoms; cycloalkylene radicals having about 3 to about 20 carbon atoms, and divalent radicals of the formula 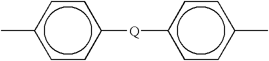
wherein Q is a divalent moiety selected from the group consisting of —O—, —S—, —C(O)—, —SO2—, and CyH₂y, wherein y is an integer from 1 to 5, and halogenated derivatives thereof.

3. The composition of claim 2, wherein V is selected from the group consisting of tetravalent aromatic radicals of formula 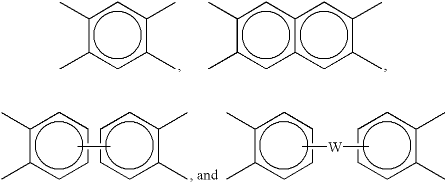
wherein W is a divalent moiety selected from the group consisting of —O—, —S—, —C(O)—, —SO₂—, CyH_{2y} wherein y is an integer from 1 to 5, or a group of the formula —O—Z—O— wherein the divalent bonds of the —O— or the —O—Z—O— group are in the 3,3′, 3,4′, 4,3′, or the 4,4′ positions, and wherein Z is selected from the group consisting of divalent radicals of formula 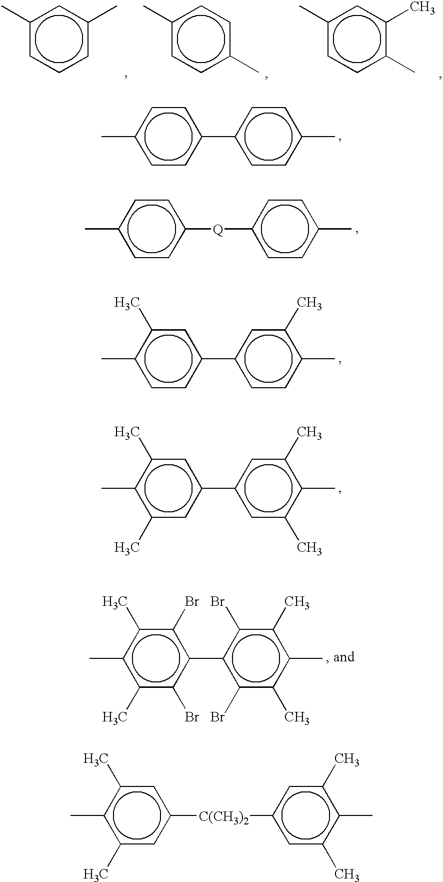
wherein Q is a divalent moiety selected from the group consisting of —O—, —S—, —C(O)—, —SO₂—, and CyH₂y, wherein y is an integer from 1 to 5, and halogenated derivatives thereof.

4. The composition of claim 1, wherein a thermoplastic polyimide resin comprises repeat units of the formula 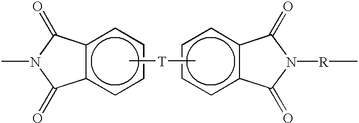
wherein T is —O— or a group of the formula —O—Z—O— wherein the divalent bonds of the —O— or the —O—Z—O— group are in the 3,3′, 3,4′, 4,3′, or the 4,4′ positions, and wherein Z is selected from the group consisting of divalent radicals of formula 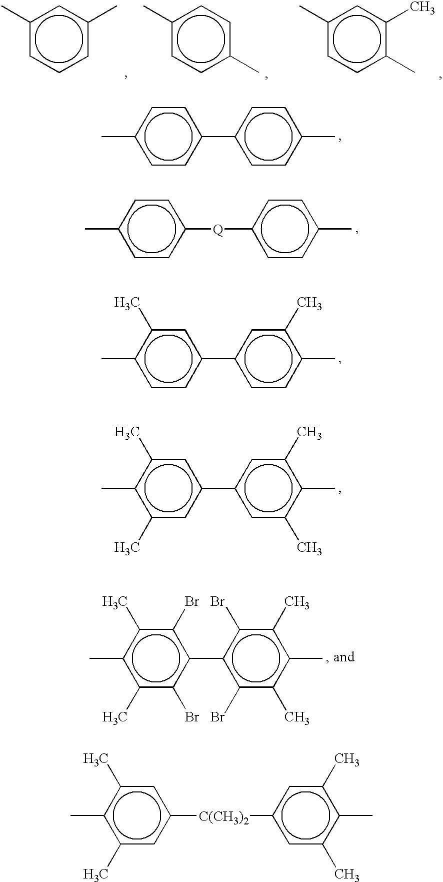
wherein Q is a divalent moiety selected from the group consisting of —O—, —S—, —C(O)—, —SO₂—, and C_{y}H_{2y}, wherein y is an integer from 1 to 5, and halogenated derivatives thereof; and R is selected from the group consisting of aromatic hydrocarbon radicals having about 6 to about 20 carbon atoms and halogenated derivatives thereof; straight and branched chain alkylene radicals having about 2 to about 20 carbon atoms; cycloalkylene radicals having about 3 to about 20 carbon atoms, and divalent radicals of the formula 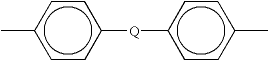
wherein Q is as defined above.

5. The composition of claim 1, wherein a thermoplastic polyimide resin comprises repeat units of the formula 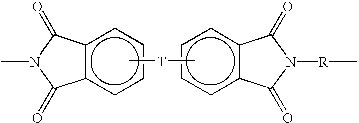
wherein R is selected from the group consisting of aromatic hydrocarbon radicals having about 6 to about 20 carbon atoms and halogenated derivatives thereof; and T is a divalent radical of the formula

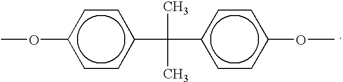

6. The composition of claim 1, wherein a thermoplastic polyimide comprises structural units of the formula 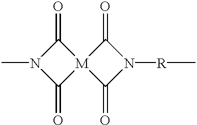
wherein R is selected from the group consisting of aromatic hydrocarbon radicals having about 6 to about 20 carbon atoms and halogenated derivatives thereof; straight or branched chain alkylene radicals having about 2 to about 20 carbon atoms; cycloalkylene radicals having about 3 to about 20 carbon atoms, or divalent radicals of the formula 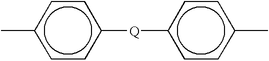
wherein Q is a divalent moiety selected from the group consisting of —O—, —S—, —C(O)—, —SO₂—, or C_{y}H_{2y}, wherein y is an integer from 1 to 5; and M is selected from the group consisting of radicals of formula

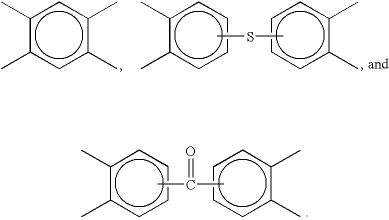

7. The composition of claim 1, wherein the second thermoplastic polymer is selected from the group consisting of polycarbonate esters, epoxy-functionalized polyolefins, poly(tetrafluoroethylene)s, polyetherimide-siloxane copolymers, polyarylates, polysulfones, polyether sulfones, and polyphenylene ethers, polyamides, polyesters, and combinations thereof.

8. The composition of claim 1, wherein the second thermoplastic polymer is selected from the group consisting of polycarbonate esters, epoxy-functionalized polyolefins, poly(tetrafluoroethylene)s, polyetherimide-siloxane copolymers, polyesters, and combinations thereof.

9. The composition of claim 1, wherein the second thermoplastic polymer is at least one polycarbonate ester comprising repeating polycarbonate chain units of the formula 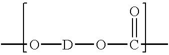
and recurring carboxylic chain units of the formula
—O—R¹—O—D—
wherein R¹ is a divalent moiety of the formulae: 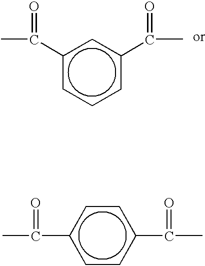
or the corresponding naphthalene derivatives, or mixtures thereof; and wherein each D is independently a divalent aromatic radical of a dihydric phenol represented by the formula 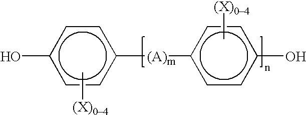
wherein A is selected from the group consisting of a divalent hydrocarbon radical containing from 1 to about 15 carbon atoms, a substituted divalent hydrocarbon radical containing from 1 to about 15 carbon atoms, —C(O)—, —S—, —SS—, —S(O)₂—, —O—, and —S(O)—; each X is independently selected from the group consisting of hydrogen, halogen, and a monovalent hydrocarbon radical, wherein said hydrocarbon radical is an alkyl group of from 1 to about 8 carbon atoms, an aryl group of from 6 to about 18 carbon atoms, an aralkyl group of from 7 to 14 carbon atoms, an alkaryl group of from 7 to about 14 carbon atoms, or an alkoxy group of from 1 to about 8 carbon atoms; and m is 0 or 1 and n is an integer of from 0 to about 5.

10. The composition of claim 1, wherein the second polymer is an epoxy-functionalized polyolefin comprising structural units derived from ethylene and glycidyl methacrylate, with epoxy groups present in an amount in the range of from about 3 wt. % to about 18 wt. %.

11. The composition of claim 10 further comprising a poly(tetrafluoroethylene).

12. The composition of claim 1, wherein the poly(diorganosiloxane) has the formula 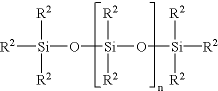
wherein each R² independently is hydrogen, C₁₋₁₅ alkyl, halogenated C₁₋₁₅ alkyl, fluorinated C₁₋₁₅ alkyl, C₂₋₁₀ alkenyl, C₅₋₁₂ cycloalkyl, C₆₋₁₂ aryl, or C₇₋₁₈ alkaryl, and wherein n is such that the compound has a nominal weight average molecular weight of from about 100,000 to about 1,500,000 grams/mole.

13. The composition of claim 12, wherein the poly(diorganosiloxane) has the formula MDₓM, or the formula M^{Vi}-DₓD^{Vi}y-M^{Vi} containing about 0.25 mole % Vi groups.

14. The composition of claim 12, wherein the poly(diorganosiloxane) has a penetration value of less than or equal to about 800 mm.

15. The composition of claim 3, wherein the poly(diorganosiloxane) has the formula 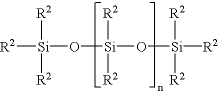
wherein each R² independently is hydrogen, C₁₋₁₅ alkyl, halogenated C₁₋₁₅ alkyl, fluorinated C₁₋₁₅ alkyl, C₂₋₁₀ alkenyl, C₅₋₁₂ cycloalkyl, C₆₋₁₂ aryl, or C₇₋₁₈ alkaryl, and wherein n is such that the compound has a nominal weight average molecular weight of from about 100,000 to about 1,500,000 grams/mole.

16. The composition of claim 15, wherein the poly(diorganosiloxane) has the formula MDₓM, or the formula M^{Vi}-DₓD^{Vi}y—M^{Vi} containing about 0.25 mole % Vi groups.

17. The composition of claim 15, wherein the poly(diorganosiloxane) has a penetration value of less than or equal to about 800 mm.

18. The composition of claim 8, wherein the poly(diorganosiloxane) has the formula 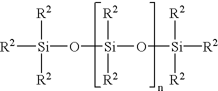
wherein each R² independently is hydrogen, C₁₋₁₅ alkyl, halogenated C₁₋₁₅ alkyl, fluorinated C₁₋₁₅ alkyl, C₂₋₁₀ alkenyl, C₅₋₁₂ cycloalkyl, C₆₋₁₂ aryl, or C₇₋₁₈ alkaryl, and wherein n is such that the compound has a nominal weight average molecular weight of from about 100,000 to about 1,500,000 grams/mole.

19. The composition of claim 18, wherein the poly(diorganosiloxane) has the formula MDₓM, or the formula MVi-DₓD^{Vi}y-M^{Vi} containing about 0.25 mole % Vi groups.

20. The composition of claim 18, wherein the poly(diorganosiloxane) has a penetration value of less than or equal to about 800 mm.

21. The composition of claim 1, further comprising at least one additive selected from the group consisting of pigments, titanium dioxide, carbon black, reinforcing agents, fillers, fumed silica, mold release agents, flow promoters, processing aids, colorants, ultraviolet screening agents, lubricants, viscosity modifiers, heat stabilizers, flame retardants, and combinations thereof.

22. An article of manufacture molded from the composition of claim 1.

23. A method of making a polyimide molding composition, which comprises blending
(a) at least one thermoplastic polyimide resin;
(b) at least one second thermoplastic resin which is chemically distinct from the polyimide resin; and
(c) a poly(diorganosiloxane).

24. The method of claim 23, wherein a polyimide resin (a) comprises repeat units of the formula 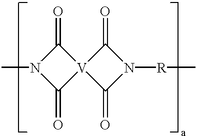
wherein a is an integer from about 10 to about 10,000; V is a tetravalent linker selected from the group consisting of substituted and unsubstituted, saturated, unsaturated and aromatic monocyclic and polycyclic groups having about 5 to about 50 carbon atoms, substituted and unsubstituted, linear and branched, saturated and unsaturated alkyl groups having 1 to about 30 carbon atoms; and combinations thereof; and R is selected from the group consisting of aromatic hydrocarbon radicals having about 6 to about 20 carbon atoms and halogenated derivatives thereof; straight and branched chain alkylene radicals having about 2 to about 20 carbon atoms; cycloalkylene radicals having about 3 to about 20 carbon atoms, and divalent radicals of the formula 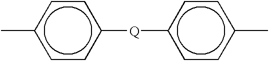
wherein Q is a divalent moiety selected from the group consisting of —O—, —S—, —C(O)—, —SO₂—, and C_{y}H_{2y}, wherein y is an integer from 1 to 5, and halogenated derivatives thereof.

25. The method of claim 24, wherein V is selected from the group consisting of tetravalent aromatic radicals of formula 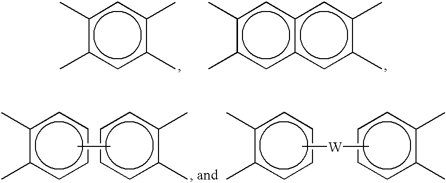
wherein W is a divalent moiety selected from the group consisting of —O—, —S—, —C(O)—, —SO₂—, CyH₂y wherein y is an integer from 1 to 5, or a group of the formula —O—Z—O— wherein the divalent bonds of the —O— or the —O—Z—O— group are in the 3,3′, 3,4′, 4,3′, or the 4,4′ positions, and wherein Z is selected from the group consisting of divalent radicals of formula 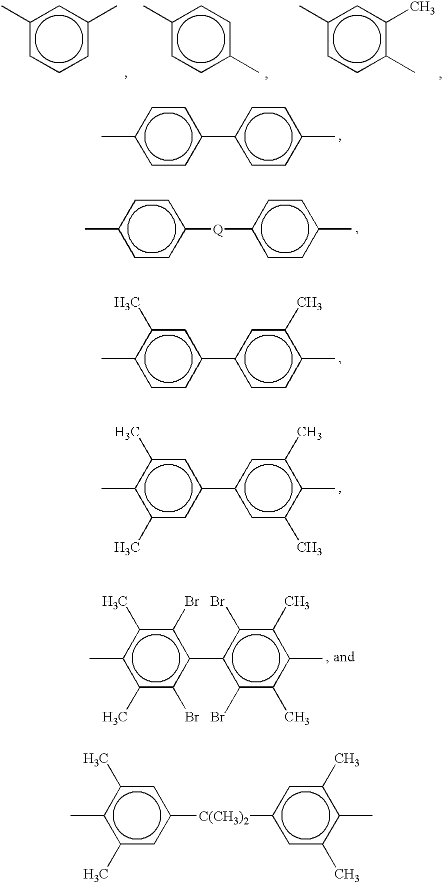
wherein Q is a divalent moiety selected from the group consisting of —O—, —S—, —C(O)—, —SO₂—, and C_{y}H_{2y}, wherein y is an integer from 1 to 5, and halogenated derivatives thereof.

26. The method of claim 23, wherein a thermoplastic polyimide resin comprises repeat units of the formula 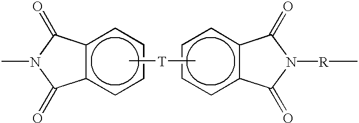
wherein T is —O— or a group of the formula —O—Z—O— wherein the divalent bonds of the —O— or the —O—Z—O— group are in the 3,3′, 3,4′, 4,3′, or the 4,4′ positions, and wherein Z is selected from the group consisting of divalent radicals of formula 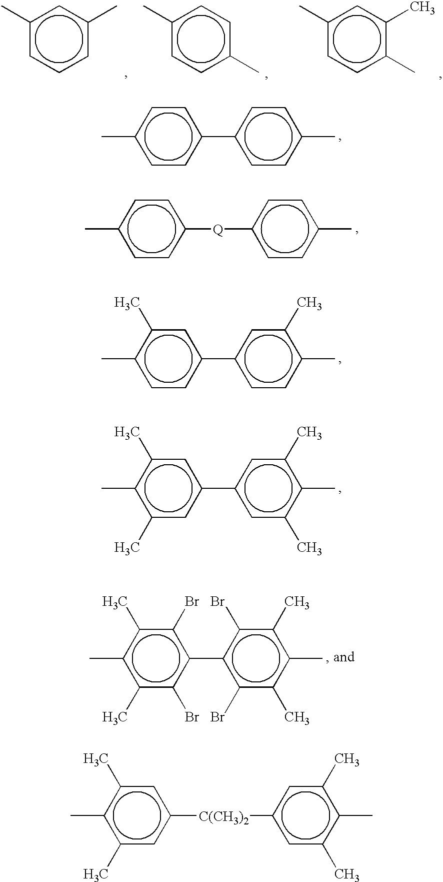
wherein Q is a divalent moiety selected from the group consisting of —O—, —S—, —C(O)—, —SO₂—, and C_{y}H_{2y}, wherein y is an integer from 1 to 5, and halogenated derivatives thereof; and R is selected from the group consisting of aromatic hydrocarbon radicals having about 6 to about 20 carbon atoms and halogenated derivatives thereof; straight and branched chain alkylene radicals having about 2 to about 20 carbon atoms; cycloalkylene radicals having about 3 to about 20 carbon atoms, and divalent radicals of the formula 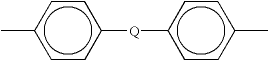
wherein Q is as defined above.

27. The method of claim 23, wherein a thermoplastic polyimide resin comprises repeat units of the formula 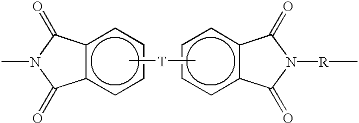
wherein R is selected from the group consisting of aromatic hydrocarbon radicals having about 6 to about 20 carbon atoms and halogenated derivatives thereof; and T is a divalent radical of the formula

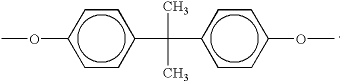

28. The method of claim 23, wherein a thermoplastic polyimide comprises structural units of the formula 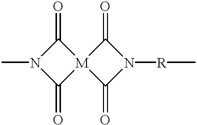
wherein R is selected from the group consisting of aromatic hydrocarbon radicals having about 6 to about 20 carbon atoms and halogenated derivatives thereof; straight or branched chain alkylene radicals having about 2 to about 20 carbon atoms; cycloalkylene radicals having about 3 to about 20 carbon atoms, or divalent radicals of the formula 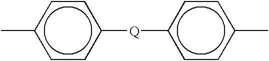
wherein Q is a divalent moiety selected from the group consisting of —O—, —S—, —C(O)—, —SO2—, or C_{y}H_{2y}, wherein y is an integer from 1 to 5; and M is selected from the group consisting of radicals of formula

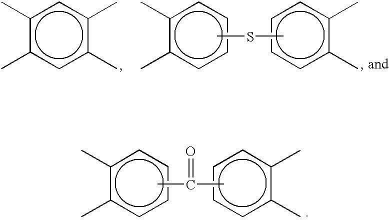

29. The method of claim 23, wherein the second thermoplastic polymer is selected from the group consisting of polycarbonate esters, epoxy-functionalized polyolefins, poly(tetrafluoroethylene)s, polyetherimide-siloxane copolymers, polyarylates, polysulfones, polyether sulfones, and polyphenylene ethers, polyamides, polyesters, and combinations thereof.

30. The method of claim 23, wherein the second thermoplastic polymer is selected from the group consisting of polycarbonate esters, epoxy-functionalized polyolefins, poly(tetrafluoroethylene)s, polyetherimide-siloxane copolymers, polyesters, and combinations thereof.

31. The method of claim 23, wherein the second thermoplastic polymer is at least one polycarbonate ester comprising repeating polycarbonate chain units of the formula 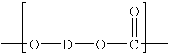
and recurring carboxylic chain units of the formula
—O—R¹—O—D—
wherein R¹ is a divalent moiety of the formulae: 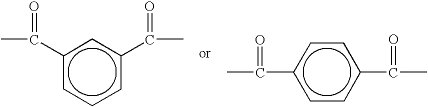
or the corresponding naphthalene derivatives, or mixtures thereof; and wherein each D is independently a divalent aromatic radical of a dihydric phenol represented by the formula 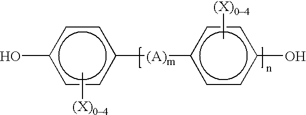
wherein A is selected from the group consisting of a divalent hydrocarbon radical containing from 1 to about 15 carbon atoms, a substituted divalent hydrocarbon radical containing from 1 to about 15 carbon atoms, —C(O)—, —S—, —S(O)₂—, —O—, and —S(O)—; each X is independently selected from the group consisting of hydrogen, halogen, and a monovalent hydrocarbon radical, wherein said hydrocarbon radical is an alkyl group of from 1 to about 8 carbon atoms, an aryl group of from 6 to about 18 carbon atoms, an aralkyl group of from 7 to 14 carbon atoms, an alkaryl group of from 7 to about 14 carbon atoms, or an alkoxy group of from 1 to about 8 carbon atoms; and m is 0 or 1 and n is an integer of from 0 to about 5.

32. The method of claim 23, wherein the second polymer is an epoxy-functionalized polyolefin comprising structural units derived from ethylene and glycidyl methacrylate, with epoxy groups present in an amount in the range of from about 3 wt. % to about 18 wt. %.

33. The method of claim 32 further comprising a poly(tetrafluoroethylene).

34. The method of claim 23, wherein the poly(diorganosiloxane) has the formula 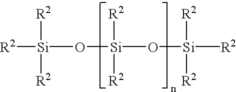
wherein each R² independently is hydrogen, C₁₋₅ alkyl, halogenated C₁₋₁₅ alkyl, fluorinated C₁₋₁₅ alkyl, C₂₋₁₀ alkenyl, C₅₋₁₂ cycloalkyl, C₆₋₁₂ aryl, or C₇₋₁₈ alkaryl, and wherein n is such that the compound has a nominal weight average molecular weight of from about 100,000 to about 1,500,000 grams/mole.

35. The method of claim 34, wherein the poly(diorganosiloxane) has the formula MDₓM, or the formula M^{Vi}-DₓD^{Vi}y-M^{Vi} containing about 0.25 mole % Vi groups.

36. The method of claim 34, wherein the poly(diorganosiloxane) has a penetration value of less than or equal to about 800 mm.

37. The method of claim 25, wherein the poly(diorganosiloxane) has the formula 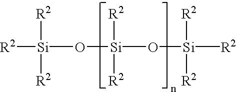
wherein each R² independently is hydrogen, C₁₋₁₅ alkyl, halogenated C₁₋₁₅ alkyl, fluorinated C₁₋₁₅ alkyl, C₂₋₁₀ alkenyl, C₅₋₁₂ cycloalkyl, C₆₋₁₂ aryl, or C₇₋₁₈ alkaryl, and wherein n is such that the compound has a nominal weight average molecular weight of from about 100,000 to about 1,500,000 grams/mole.

38. The method of claim 37, wherein the poly(diorganosiloxane) has the formula MDₓM, or the formula M^{Vi}-DₓD^{Vi}y-M^{Vi} containing about 0.25 mole % Vi groups.

39. The method of claim 37, wherein the poly(diorganosiloxane) has a penetration value of less than or equal to about 800 mm.

40. The method of claim 30, wherein the poly(diorganosiloxane) has the formula 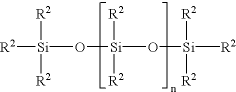
wherein each R² independently is hydrogen, C₁₋₁₅ alkyl, halogenated C₁₋₁₅ alkyl, fluorinated C₁₋₁₅ alkyl, C₂₋₁₀ alkenyl, C₅₋₁₂ cycloalkyl, C₆₋₁₂ aryl, or C₇₋₁₈ alkaryl, and wherein n is such that the compound has a nominal weight average molecular weight of from about 100,000 to about 1,500,000 grams/mole.

41. The method of claim 40, wherein the poly(diorganosiloxane) has the formula MDₓM, or the formula M^{Vi}-DₓD^{Vi}y-M^{Vi} containing about 0.25 mole % Vi groups.

42. The method of claim 40, wherein the poly(diorganosiloxane) has a penetration value of less than or equal to about 800 mm.

43. The method of claim 23, further comprising at least one additive selected from the group consisting of pigments, titanium dioxide, carbon black, reinforcing agents, fillers, mold release agents, flow promoters, processing aids, colorants, ultraviolet screening agents, lubricants, viscosity modifiers, heat stabilizers, flame retardants, and combinations thereof.

44. The method of claim 23, wherein a poly(diorganosiloxane) is first dispersed into a matrix selected from the group consisting of at least one thermoplastic polyimide resin (a), at least one second thermoplastic resin (b) which is chemically distinct from any thermoplastic polyimide resin, a high surface area inorganic material selected from the group consisting of silica, titania, alumina, Wollastonite, clays, bentonite, kaolin, zeolites, barium sulfate, and carbon black, and a mixture of any two or more of the foregoing, prior to blending with the other components.

45. The method of claim 23, wherein a poly(diorganosiloxane) is first dispersed into an inorganic matrix selected from the group consisting of silica, titania, alumina, Wollastonite, clays, bentonite, kaolin, zeolites, barium sulfate, and carbon black, and then dispersed into an organic matrix selected from the group consisting of at least one thermoplastic polyimide resin (a), at least one second thermoplastic resin (b) which is chemically distinct from any polyimide resin, and a mixture of any two or more of the foregoing.

46. A polyimide molding composition comprising:
(a) at least one thermoplastic polyetherimide resin comprising structural units derived from meta-phenylene diamine and 2, 2-bis[4-(3,4-dicarboxyphenoxy)phenyl]propane dianhydride;
(b) a polycarbonate ester resin having about 60% ester units relative to carbonate units, and comprising structural units derived from bisphenol-A and about a 1:1 ratio of isophthalic acid to terephthalic acid;
(c) a poly(diorganosiloxane) of the formula MDₓM, or a poly(diorganosiloxane) of the formula M^{Vi}-DₓD^{Vi}_{y}-M^{Vi} containing about 0.25 mole % Vi groups; and
(d) optionally at least one additive selected from the group consisting of pigments, titanium dioxide, carbon black, reinforcing agents, fillers, fumed silica, mold release agents, flow promoters, processing aids, colorants, ultraviolet screening agents, lubricants, viscosity modifiers, heat stabilizers, flame retardants, and combinations thereof.

47. The composition of claim 46, wherein polycarbonate ester is present in the composition in the range of from about 5% to about 95%, by weight, based on combined weight of components (a) and (b); poly(diorganosiloxane) is present in the composition in the range of about 0.1-10%; and fumed silica is optionally present in the composition in an amount of from about 30 to about 100 parts by weight based on the weight of the poly(diorganosiloxane).

48. The composition of claim 47 containing fumed silica.

49. The composition of claim 48 containing carbon black.

50. The composition of claim 46 containing carbon black.

51. A polyimide molding composition comprising:
(a) at least one thermoplastic polyetherimide resin comprising structural units derived from meta-phenylene diamine and 2,2-bis[4-(3,4-dicarboxyphenoxy)phenyl]propane dianhydride;
(b) an epoxy-functionalized polyolefin comprising structural units derived from ethylene and glycidyl methacrylate, with epoxy groups present in an amount in the range of from about 3 wt. % to about 18 wt. %.;
(c) a poly(diorganosiloxane) of the formula MDₓM, or a poly(diorganosiloxane) of the formula M^{Vi}-DₓD^{Vi}_{y}-M^{Vi} containing about 0.25 mole % Vi groups; and
(d) optionally at least one additive selected from the group consisting of pigments, titanium dioxide, carbon black, reinforcing agents, fillers, fumed silica, mold release agents, flow promoters, processing aids, colorants, ultraviolet screening agents, lubricants, viscosity modifiers, heat stabilizers, flame retardants, and combinations thereof.

52. The composition of claim 51, wherein epoxy-functionalized polyolefin is present in the composition in the range of from about 1% to about 20%, by weight, based on combined weight of resinous components; poly(diorganosiloxane) is present in the composition in the range of about 0.1-10%; and fumed silica is optionally present in the composition in an amount of from about 30 to about 100 parts by weight based on the weight of the poly(diorganosiloxane).

53. The composition of claim 52 containing fumed silica.

54. The composition of claim 51 further comprising a poly(tetrafluoroethylene) present in an amount in the range from about 0.3 to about 20% based on weight of the total composition.

55. A polyimide molding composition comprising:
(a) at least one thermoplastic polyetherimide resin comprising structural units derived from meta-phenylene diamine and 2,2-bis[4-(3,4-dicarboxyphenoxy)phenyl]propane dianhydride;
(b) an epoxy-functionalized polyolefin comprising structural units derived from ethylene and glycidyl methacrylate, with epoxy groups present in an amount in the range of from about 3 wt. % to about 18 wt. %.;
(c) a polyetherimide-siloxane random copolymer containing structural units derived from meta-phenylene diamine, 2, 2-bis[4-(3,4-dicarboxyphenoxy)-phenyl]propane dianhydride, and a poly(dimethylsiloxane) of the formula 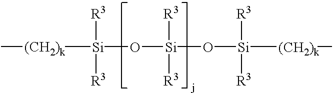
wherein k is 3 and j is about 10;
(d) a poly(tetrafluoroethylene); and
(e) optionally at least one additive selected from the group consisting of pigments, titanium dioxide, carbon black, reinforcing agents, fillers, fumed silica, mold release agents, flow promoters, processing aids, colorants, ultraviolet screening agents, lubricants, viscosity modifiers, heat stabilizers, flame retardants, and combinations thereof.

56. The composition of claim 55, wherein epoxy-functionalized polyolefin is present in the composition in the range of from about 1% to about 20%, by weight, based on combined weight of resinous components; polyetherimide-siloxane copolymer is present in the composition in the range of about 0.1-10%; and poly(tetrafluoroethylene) is present in an amount in the range of from about 0.3 to about 20% based on weight of the total composition.
